(19) United States
(12) Patent Application Publication
(10) Pub. No.: US 2004/0041957 A1
(43) Pub. Date: Mar. 4, 2004

(54) Liquid crystal display

(76) Inventors: Hidemasa Yamaguchi, Kanagawa (JP); Tsutomu Tanaka, Kanagawa (JP); Shinji Nakamura, Kanagawa (JP); Yoko Fukunaga, Kanagawa (JP); Masumitsu Ino, Kanagawa (JP); Nobuyuki Shigeno, Tokyo (JP); Yoshiharu Nakajima, Kanagawa (JP)

Correspondence Address: ROBERT J. DEPKE LEWIS T. STEADMAN, HOLLAND & KNIGHT LLC, 131 SOUTH DEARBORN, 30TH FLOOR, CHICAGO, IL, 60603, US

(21) Appl. No.: 10/463,715

(22) Filed: Jun. 16, 2003

(30) Foreign Application Priority Data
Jun. 17, 2002 (JP) P2002-175512

(51) Int. Cl. G02F 1/136

(52) U.S. Cl. 349/43; 349/113

(57) ABSTRACT

Disclosed herein is a liquid crystal display including a pair of substrates, a liquid crystal layer sandwiched between the substrates, a pixel having a transmissive display region for displaying with transmitted light and a reflective display region for displaying with reflected light, a drive element for driving the pixel, a signal line for supplying a display signal to the drive element, and a gate line for supplying a scan signal to the drive element. One of the substrates includes an insulating planarization layer for planarizing a step produced by the signal line and/or the gate line, and a transparent electrode formed on the insulating planarization layer in the transmissive display region. With this structure, the leakage of light in the black display state can be prevented to thereby improve the contrast, and the transmissive display region can be enlarged to thereby ensure a high transmissivity.

### BACKGROUND OF THE INVENTION

The present invention relates to a liquid crystal display, and more particularly to an improvement in a combined reflective/transmissive liquid crystal display.

A liquid crystal display is widely used in a notebook personal computer, car navigation system, Personal Digital Assistant (PDA), mobile telephone, etc. utilizing the features of small thickness and low power consumption. The liquid crystal display is generally classified into a transmissive liquid crystal display and a reflective liquid crystal display. The transmissive liquid crystal display has an internal light source called a backlight and performs a transmissive display by switching on and off the light emitted from the backlight through a liquid crystal panel. On the other hand, the reflective liquid crystal display has a reflecting plate or the like for reflecting incident ambient light such as sunlight and performs reflective display by switching on and off the reflected light from the reflecting plate through a liquid crystal panel.

In the transmissive liquid crystal display, the backlight consumes 50% or more of the total electric power. Accordingly, the provision of the backlight causes an increase in power consumption. Further, the transmissive liquid crystal display has another problem such that when the ambient light is bright, the display light becomes dark in viewing, causing a reduction in visibility. In the reflective liquid crystal display, an increase in power consumption can be avoided because no backlight is provided. However, when the ambient light is dark, the quantity of the reflected light is reduced to cause a great reduction in visibility.

To solve the above problems both in the transmissive liquid crystal display and in the reflective liquid crystal display, there has been proposed a combined reflective/transmissive liquid crystal display capable of realizing both the transmissive display and the reflective display through a single liquid crystal panel. In this combined reflective/transmissive liquid crystal display, the reflective display by the reflection of the ambient light is performed when the ambient light is bright, whereas the transmissive display by the transmission of the light from the backlight is performed when the ambient light is dark. Examples of the combined reflective/transmissive liquid crystal display are disclosed in Japanese Patent No. 2955277 and Japanese Patent Laid-open No. 2001-166289.

Referring to FIG. 11, there is shown a plan view of a thin film transistor (which will be hereinafter referred to as “TFT”) substrate 101 in a combined reflective/transmissive liquid crystal display in the related art. The TFT substrate 101 is provided with a plurality of pixels 102 (one of which being shown) each controlled by a TFT to be hereinafter described. The plurality of pixels 102 are arranged in a matrix form. A gate line 103 for supplying a scan signal to the TFT for each pixel 102 and a signal line 104 for supplying a display signal to the TFT for each pixel 102 are arranged orthogonally to each other so as to overlap a peripheral portion of each pixel 102.

Each pixel 102 includes a reflective display region A for performing reflective display and a transmissive display region B for performing transmissive display. In the liquid crystal display shown in FIG. 11, the rectangular transmissive display region B is surrounded by the rectangular reflective display region A.

The TFT substrate 101 is further provided with an auxiliary capacitor wiring (which will be hereinafter referred to as “Cs line”) (not shown) parallel to the gate line 103. The Cs line is formed from a metal film. As will be hereinafter described, an auxiliary capacitor C (not shown) is formed between the Cs line and a connection electrode and connected to an opposing electrode provided on a color filter substrate.

Referring to FIG. 12, there is shown a sectional structure of this related art liquid crystal display as taken along the line J-J′ in FIG. 11. As shown in FIG. 12, this related art liquid crystal display has such a sectional structure that a color filter substrate 105 is opposed to the TFT substrate 101 and a liquid crystal layer 106 is sandwiched between the color filter substrate 105 and the TFT substrate 101.

The color filter substrate 105 has a transparent insulating substrate 107 formed of glass or the like, a color filter 108 formed on the transparent insulating substrate 107 so as to be opposed to the TFT substrate 101, and an opposing electrode 109 formed on the color filter 108 so as to be opposed to the TFT substrate 101. The opposing electrode 109 is formed of ITO or the like. The color filter 108 is composed of a plurality of resin layers differently colored by pigment or dye. For example, R, G, and B color filter layers are used in combination to configure the color filter 108.

A λ/4 layer 110 and a polarizing plate 111 are provided in this order on the color filter substrate 105 opposite to the color filter 108 and the opposing electrode 109.

In the reflective display region A of the TFT substrate 101, a TFT 113 as a switching element for supplying a display signal to each pixel 102 is formed on a transparent insulating substrate 112 of a transparent material such as glass. A reflective irregularity forming layer 114 is formed over the TFT 113 through several layers of insulating films to be hereinafter described in detail. A planarization layer 115 is formed on the reflective irregularity forming layer 114. An ITO film 116a is formed on the planarization layer 115, and a reflective electrode 117 is formed on the ITO film 116a.

The TFT 113 shown in FIG. 12 has a so-called bottom gate structure. That is, the TFT 113 has a gate electrode 118 formed on the transparent insulating substrate 112, a gate insulator 119 as a multilayer film composed of a silicon nitride film 119a and a silicon oxide film 119b formed sequentially on the gate electrode 118, and a semiconductor thin film 120 formed on the gate insulator 119. The semiconductor thin film 120 has a pair of N⁺ diffused regions horizontally opposite to each other with respect to the gate electrode 118. The gate electrode 118 is formed by extending a part of the gate line 103, and it is a metal or alloy film of molybdenum (Mo), tantalum (Ta), etc. deposited by sputtering or the like.

A source electrode 128 is connected to one of the N+diffused regions of the semiconductor thin film 120 through a contact hole formed through a first interlayer dielectric 121 and a second interlayer dielectric 122. The signal line 104 is connected to the source electrode 128 to input a data signal to the source electrode 128. On the other hand, a drain electrode 129 is connected to the other N⁺ diffused region of the semiconductor thin film 120 through another contact hole formed through the first interlayer dielectric 121 and the second interlayer dielectric 122. The drain electrode 129 is connected to a connection electrode and further electrically connected through a contact portion to the corresponding pixel 102. An auxiliary capacitor C is formed between the connection electrode and a Cs line 123 through the gate insulator 119. The semiconductor thin film 120 is a low-temperature polysilicon thin film obtained by Chemical Vapor Deposition (CVD), for example, and this film 120 is formed at a position aligned with the gate electrode 118 through the gate insulator 119.

A stopper 124 is provided just over the semiconductor thin film 120 through the first interlayer dielectric 121 and the second interlayer dielectric 122. The stopper 124 functions to protect the semiconductor thin film 120 formed at the position aligned with the gate electrode 118.

In the transmissive display region B of the TFT substrate 101, the various insulating films formed over the substantially entire surface of the transparent insulating substrate 112 in the reflective display region A are absent. That is, the gate insulator 119, the first and second interlayer dielectrics 121 and 122, the reflective irregularity forming layer 114, and the planarization layer 115 are all absent in the transmissive display region A, and a transparent electrode 116 is formed directly on the transparent insulating substrate 112. Further, the reflective electrode 117 formed in the reflective display region A is also not formed in the transmissive display region B.

As in the case of the color filter substrate 105, a λ/4 layer 126 and a polarizing plate 127 are provided in this order on the transparent insulating substrate 112 opposite to the TFT 113, that is, on the same side where a backlight 125 as an internal light source is provided.

Referring to FIG. 13, there is shown a sectional structure of this related art liquid crystal display as taken along the line K-K′ in FIG. 11, that is, a sectional structure as taken along a line across the transmissive display region B in parallel to the corresponding gate line 103. As shown in FIG. 13, the transparent electrode 116 is formed on the transparent insulating substrate 112 in a region defined between the adjacent signal lines 104, thereby forming the transmissive display region B. Further, the color filter 108 is arranged at a position in the color filter substrate 105 corresponding to the transparent electrode 116.

In the combined reflective/transmissive liquid crystal display, however, there arises a problem such that the leakage of light in the black display state is prone to occur at a step between the reflective display region A and the transmissive display region B shown in FIG. 12, causing a reduction in contrast. The leakage of light in the black display state is due to the fact that a region where the orientation of liquid crystal molecules is disordered is generated at this step or that the cell gap lacks at this step to cause a deviation in phase difference.

Such a reduction in contrast due to the leakage of light in the black display state tends to become more remarkable in a structure that emphasis is placed on the transmissive display as shown in FIG. 14. In this structure, the transparent electrode 116 is extended to such a degree that it overlaps the adjacent signal lines 104, so as to enlarge the transmissive display region B. In this case, the transparent electrode 116 is stepped by the reflection of a step produced by each signal line 104, thus resulting in a more remarkable reduction in contrast.

Further, as shown in FIGS. 13 and 14, a black matrix 128 as a light shield is arranged in a region corresponding to the signal lines 104 and the gate lines 103 where the leakage of light possibly occurs, thereby preventing the light leakage. However, the use of the black matrix 128 sacrifices the transmissivity. Thus, a technique capable of achieving both a high transmissivity and an improvement in contrast has not yet been established at present.

### SUMMARY OF THE INVENTION

It is accordingly an object of the present invention to provide a combined reflective/transmissive liquid crystal display that can enlarge the transmissive display region to thereby ensure a high transmissivity and can also prevent the leakage of light in the black display state to thereby improve the contrast.

According to the present invention, there is provided a liquid crystal display including a pair of substrates, a liquid crystal layer sandwiched between the substrates, a pixel having a transmissive display region for displaying with transmitted light and a reflective display region for displaying with reflected light, a drive element for driving the pixel, a signal line for supplying a display signal to the drive element, and a gate line for supplying a scan signal to the drive element. One of the substrates includes an insulating planarization layer for planarizing a step produced by the signal line and/or the gate line, and a transparent electrode formed on the insulating planarization layer in the transmissive display region.

In the liquid crystal display having the above configuration, the underlayer of the transparent electrode is planarized by the insulating planarization layer. Accordingly, the planarity of the transparent electrode can be ensured without the dependence on the shape of the step produced by the signal line and/or the gate line. For example, even in the case that the transmissive display region is enlarged so as to overlap the signal line and/or the gate line, no step appears on the surface of the transparent electrode. As a result, the leakage of light in the transmissive display region can be prevented in the black display state.

### BRIEF DESCRIPTION OF THE DRAWINGS

These and other objects of the invention will be seen by reference to the description in connection with the accompanying drawing, in which:

FIG. 1 is a plan view of a TFT substrate in a combined reflective/transmissive liquid crystal display according to a first preferred embodiment of the present invention;

FIG. 2 is a cross section taken along the line C-C′ in FIG. 1;

FIG. 3 is a cross section taken along the line D-D′ in FIG. 1;

FIG. 4 is an enlarged sectional view of a region near each signal line shown in FIG. 3;

FIG. 5 is a view similar to FIG. 4, showing a modification;

FIG. 6 is a sectional view of a region near each signal line in a conventional liquid crystal display having a structure such that a transmissive display region is not planarized;

FIG. 7 is a view similar to FIG. 6, showing another example;

FIG. 8 is a plan view of a TFT substrate in a combined reflective/transmissive liquid crystal display according to a second preferred embodiment of the present invention;

FIG. 9 is a cross section taken along the line G-G′ in FIG. 8;

FIG. 10 is a plan view of a TFT substrate in a combined reflective/transmissive liquid crystal display according to a third preferred embodiment of the present invention;

FIG. 11 is a plan view of a TFT substrate in a combined reflective/transmissive liquid crystal display in the related art;

FIG. 12 is a cross section taken along the line J-J′ in FIG. 11;

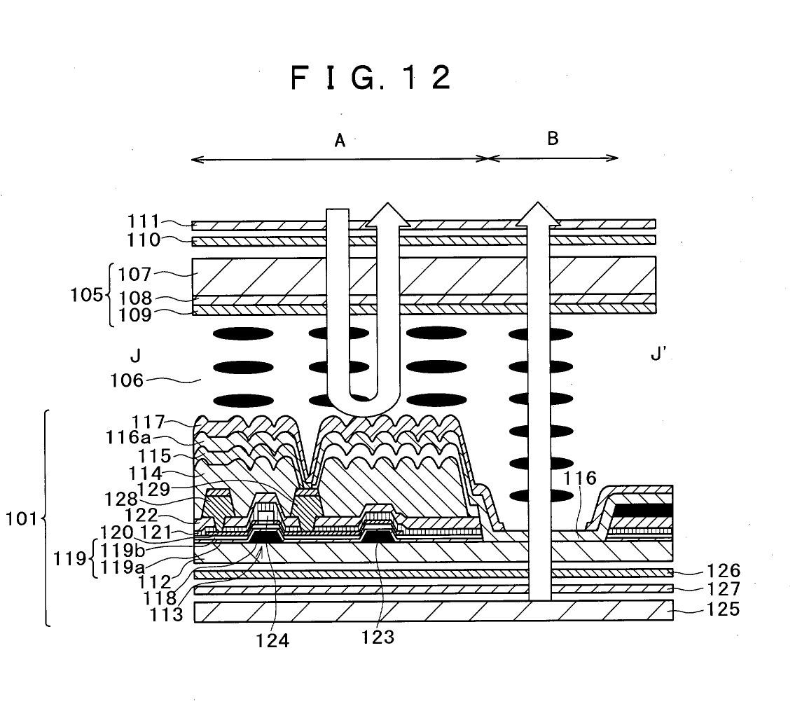

FIG. 13 is a cross section taken along the line K-K′ in FIG. 11; and

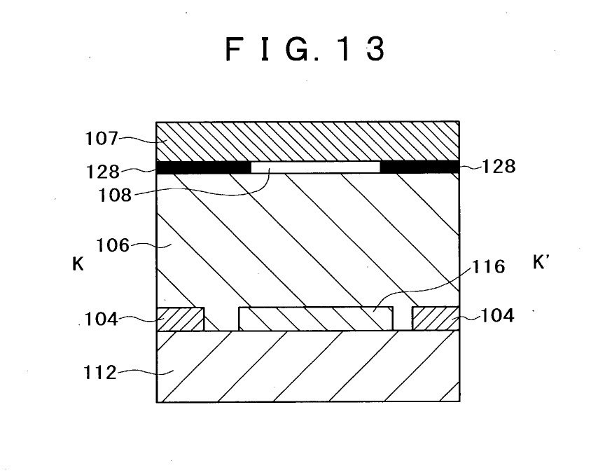

FIG. 14 is a view similar to FIG. 13, showing another example.

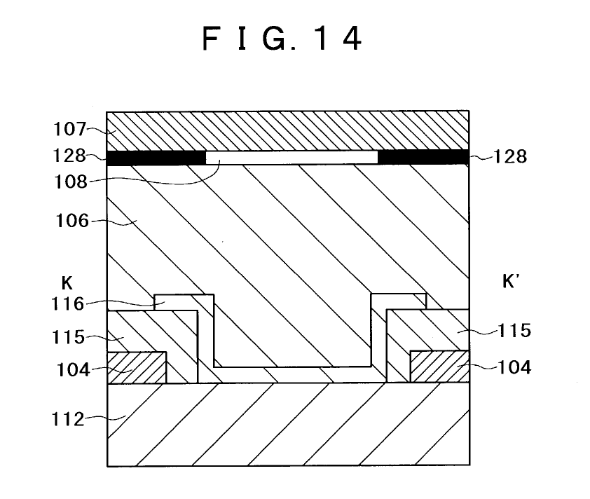

### DETAILED DESCRIPTION OF THE PREFERRED EMBODIMENTS

Some preferred embodiments of the present invention will now be described in detail with reference to the drawings. In some of the drawings, characteristic parts of the present invention are enlarged for ease of illustration, and the ratio in dimension between components is not necessarily the same as the actual ratio.

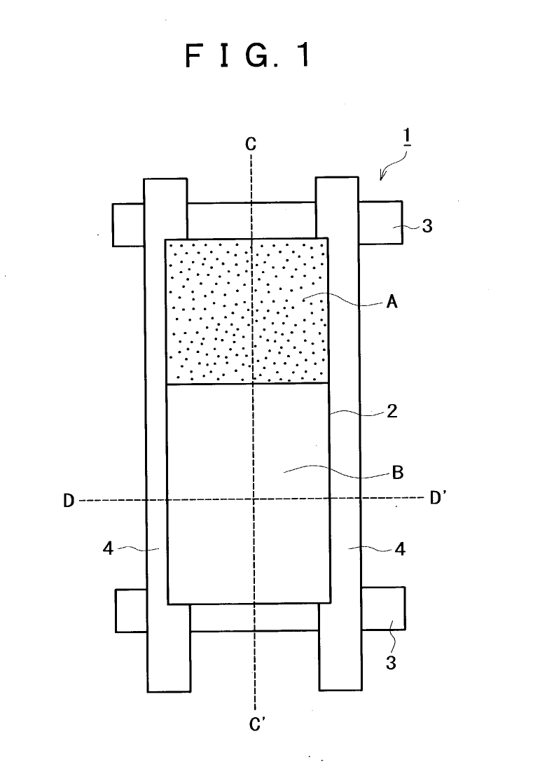

Referring to FIG. 1, there is shown a plan view of a TFT substrate 1 in a combined reflective/transmissive liquid crystal display according to a preferred embodiment of the present invention. The TFT substrate 1 is provided with a plurality of pixels 2 (one of which being shown) each controlled by a TFT to be hereinafter described. The plurality of pixels 2 are arranged in a matrix form. A gate line 3 for supplying a scan signal to the TFT for each pixel 2 and a signal line 4 for supplying a display signal to the TFT for each pixel 2 are arranged orthogonally to each other so as to overlap a peripheral portion of each pixel 2.

The TFT substrate 1 is further provided with an auxiliary capacitor wiring (which will be hereinafter referred to as “Cs line”) (not shown) parallel to the gate line 3. The Cs line is formed from a metal film. As will be hereinafter described, an auxiliary capacitor C is formed between the Cs line and a connection electrode and connected to an opposing electrode provided on a color filter substrate.

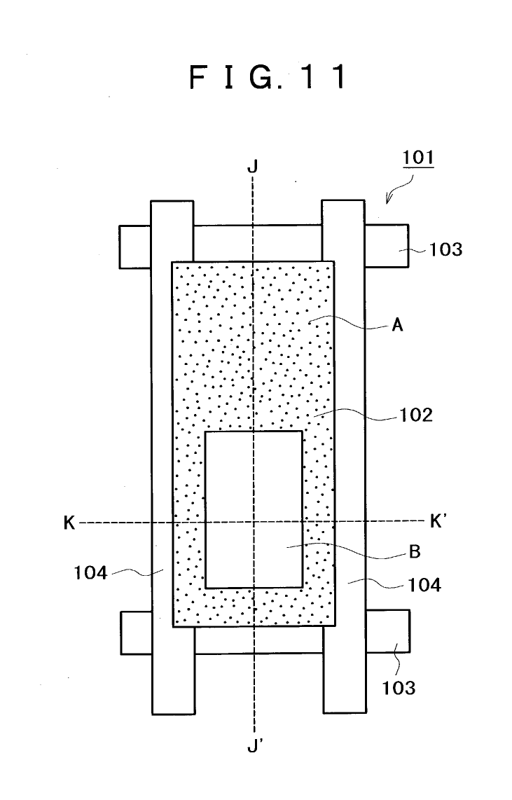

Each pixel 2 includes a reflective display region A for performing reflective display and a transmissive display region B for performing transmissive display. In the liquid crystal display shown in FIG. 1, the transmissive display region B contributing to transmissive display is set larger in size than that in the related art shown in FIG. 11, so as to improve the display quality of transmissive display. More specifically, as compared with the related art liquid crystal display having such a structure that the transmissive display region B is surrounded by the reflective display region A, the liquid crystal display according to the present invention has such a structure that each pixel 2 is divided in one direction (in a direction parallel to the signal line 4 in this preferred embodiment) to form the reflective display region A and the transmissive display region B in such a manner that the reflective display region A and the transmissive display region B are arranged along a single straight boundary extending parallel to the gate line 3. That is, unlike the related art liquid crystal display shown in FIG. 11, the liquid crystal display according to the present invention has such a structure that the reflective display region A is not present between the transmissive display region B and each of the adjacent signal lines 4 and between the transmissive display region B and one of the adjacent gate lines 3.

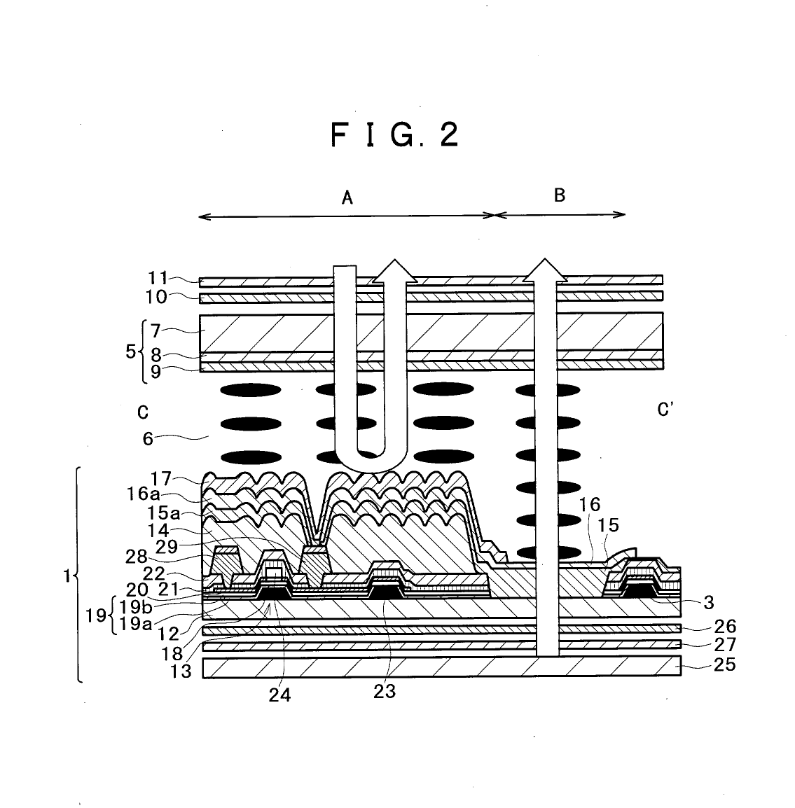

Referring to FIG. 2, there is shown a sectional structure of the liquid crystal display according to this preferred embodiment as taken along the line C-C′ in FIG. 1, that is, a sectional structure as taken along a substantially central line of each pixel 2 parallel to the corresponding signal line 4. As shown in FIG. 2, this liquid crystal display has such a sectional structure that a color filter substrate 5 is opposed to the TFT substrate 1 and a liquid crystal layer 6 is sandwiched between the color filter substrate 5 and the TFT substrate 1.

The color filter substrate 5 has a transparent insulating substrate 7 formed of glass or the like, a color filter 8 formed on the transparent insulating substrate 7 so as to be opposed to the TFT substrate 1, and an opposing electrode 9 formed on the color filter 8 so as to be opposed to the TFT substrate 1. The opposing electrode 9 is formed of ITO or the like. The color filter 8 is composed of a plurality of resin layers differently colored by pigment or dye. For example, R, G, and B color filter layers are used in combination to configure the color filter 8.

In the combined reflective/transmissive liquid crystal display according to this preferred embodiment, the transmissive display is performed by the light emitted from a backlight and once passing through the color filter 8, whereas the reflective display is performed by the ambient light first passing through the color filter 8 upon incidence and secondly passing through the color filter 8 upon emergence after reflection. That is, the incident ambient light is twice passed through the color filter 8. Thus, the number of times of pass of light through the color filter 8 in performing the reflective display is larger by one than that in performing the transmissive display, so that the attenuation of light in the reflective display region A is much larger than that in the transmissive display region B, causing a reduction in reflectivity. It is therefore desirable to reduce the light attenuation in the reflective display region A and thereby improve the reflectivity, by any methods such as a method of forming an opening through a portion of the color filter 8 corresponding to the reflective display region A, a method of reducing the film thickness of the color filter 8, and a method of changing the pigment dispersed in the resin for the color filter 8 into a material suitable for the reflective display. Of these methods, the method of forming an opening through a portion of the color filter 8 corresponding to the reflective display region A is preferable. According to this method, the amount of light passing through the color filter 8 can be controlled according to the size of the opening, so that the portion of the color filter 8 corresponding to the reflective display region A and the portion of the color filter 8 corresponding to the transmissive display region B can easily formed under the same conditions, specifically with the same film thickness, the same material, and the same process step. Accordingly, the reflectivity in the reflective display region A can be improved without increasing the number of fabrication steps. Further, the luminance and color reproducibility can be improved to improve the visibility in the reflective display region A.

A λ/4 layer 10 and a polarizing plate 11 are provided in this order on the color filter substrate 5 opposite to the color filter 8 and the opposing electrode 9.

In the reflective display region A of the TFT substrate 1, a TFT 13 as a switching element for supplying a display signal to each pixel 2 is formed on a transparent insulating substrate 12 of a transparent material such as glass. A reflective irregularity forming layer 14 is formed over the TFT 13 through several layers of insulating films to be hereinafter described in detail. A planarization layer 15a is formed on the reflective irregularity forming layer 14. An ITO film 16a is formed on the planarization layer 15a, and a reflective electrode 17 is formed on the ITO film 16a. The reflective irregularity forming layer 14 is a layer for forming irregularities on the surface of the reflective electrode 17 to make it have diffusibility of light, thereby obtaining a good image quality. The planarization layer 15a is a layer for relaxing the irregularities produced by the reflective irregularity forming layer 14 to further improve the reflective display quality.

While the ITO film 16a and a transparent electrode 16 to be hereinafter described are simultaneously formed and integrated as a common film in the liquid crystal display shown in FIG. 1, a portion of this common film present in the reflective display region A and a portion of this common film present in the transmissive display region B will be separately referred to as the ITO film 16a and the transparent electrode 16, respectively, for ease of illustration. Similarly, while the planarization layer 15a and an insulating planarization layer 15 to be hereinafter described are simultaneously formed and integrated as a common layer, a portion of this common layer present in the reflective display region A and a portion of this common layer present in the transmissive display region B will be separately referred to as the planarization layer 15a and the insulating planarization layer 15, respectively, for the same reason.

The TFT 13 shown in FIG. 2 has a so-called bottom gate structure. That is, the TFT 13 has a gate electrode 18 formed on the transparent insulating substrate 12, a gate insulator 19 as a multilayer film composed of a silicon nitride film 19a and a silicon oxide film 19b formed sequentially on the gate electrode 18, and a semiconductor thin film 20 formed on the gate insulator 19. The semiconductor thin film 20 has a pair of N⁺ diffused regions horizontally opposite to each other with respect to the gate electrode 18. The gate electrode 18 is formed by extending a part of the gate line 3, and it is a metal or alloy film of molybdenum (Mo), tantalum (Ta), etc. deposited by sputtering or the like.

A source electrode 28 is connected to one of the N⁺ diffused regions of the semiconductor thin film 20 through a contact hole formed through a first interlayer dielectric 21 and a second interlayer dielectric 22. The signal line 4 is connected to the source electrode 28 to input a data signal to the source electrode 28. On the other hand, a drain electrode 29 is connected to the other N⁺ diffused region of the semiconductor thin film 20 through another contact hole formed through the first interlayer dielectric 21 and the second interlayer dielectric 22. The drain electrode 29 is connected to a connection electrode and further electrically connected through a contact portion to the corresponding pixel 2. An auxiliary capacitor C is formed between the connection electrode and a Cs line 23 through the gate insulator 19. The semiconductor thin film 20 is a low-temperature polysilicon thin film obtained by CVD, for example, and this film 20 is formed at a position aligned with the gate electrode 18 through the gate insulator 19.

A stopper 24 is provided just over the semiconductor thin film 20 through the first interlayer dielectric 21 and the second interlayer dielectric 22. The stopper 24 functions to protect the semiconductor thin film 20 formed at the position aligned with the gate electrode 18.

In the transmissive display region B of the TFT substrate 1, the insulating planarization layer 15 is formed on the transparent insulating substrate 12 by extending a part of the planarization layer 15a formed in the reflective display region A, and the transparent electrode 16 is formed on the insulating planarization layer 15 by extending a part of the ITO film 16a formed in the reflective display region A. Further, the gate insulator 19, the first and second interlayer dielectrics 21 and 22, the reflective irregularity forming layer 14, and the reflective electrode 17 formed in the reflective display region A are all absent in the transmissive display region B.

As in the case of the color filter substrate 5, a λ/4 layer 26 and a polarizing plate 27 are provided in this order on the transparent insulating substrate 12 opposite to the TFT 13, that is, on the same side where a backlight 25 as an internal light source is provided.

The liquid crystal layer 6 sandwiched between the TFT substrate 1 and the color filter substrate 5 is composed of nematic liquid crystal molecules having positive dielectric anisotropy. When no voltage is applied, the liquid crystal molecules are oriented parallel to each substrate, whereas when a voltage is applied, the liquid crystal molecules are oriented perpendicularly to each substrate. The brightness can be controlled by controlling the birefringence of the liquid crystal molecules according to the applied voltage. The configuration of the liquid crystal layer 6 is not limited to the above configuration. For example, the liquid crystal layer 6 may be configured so that when a voltage is applied, the liquid crystal molecules are oriented parallel to each substrate, whereas no voltage is applied, the liquid crystal molecules are oriented perpendicularly to each substrate.

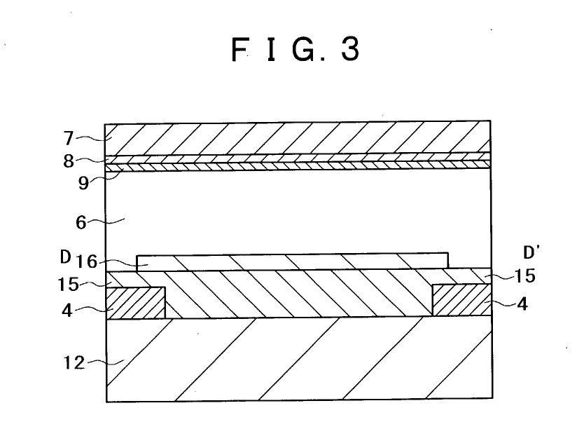

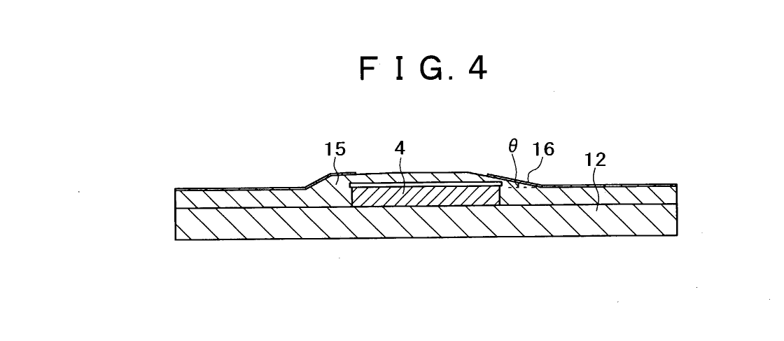

Referring to FIG. 3, there is shown a sectional structure of the liquid crystal display according to this preferred embodiment as taken along the line D-D′ in FIG. 1, that is, a sectional structure as taken along a substantially central line of the transmissive display region B parallel to the corresponding gate line 3. FIG. 4 shows an enlarged sectional structure near each signal line 4.

As shown in FIGS. 3 and 4, the signal line 4 is covered with the insulating planarization layer 15. Accordingly, although the signal line 4 and the transparent electrode 16 are overlapped (partially overlaid) each other, reliable insulation between the signal line 4 and the transparent electrode 16 can be provided. As a result, enlargement of the transmissive display region B in the vicinity of the signal line 4 difficult in the related art can be expected.

Further, since the insulating planarization layer 15 is formed so as to cover the signal line 4 over the substantially entire surface of the transparent insulating substrate 12 in the transmissive display region B, the transparent electrode 16 can be formed with high planarity. Accordingly, even when the transparent electrode 16 is formed so as to overlap the signal line 4, the planarity of the underlayer of the transparent electrode 16 is ensured, thereby preventing the leakage of light in the black display state due to a step produced by the transparent electrode 16.

Further, since the planarity of the transparent electrode 16 is ensured to prevent the leakage of light in the black display state, the black matrix provided on the color filter substrate 5 in the related art can be eliminated as shown in FIG. 3. As a result, a reduction in transmissivity due to the black matrix can be eliminated to thereby remarkably improve the transmissivity, so that the display quality in the transmissive display region B can be further improved.

The transmissivity may be improved also by combining the conventional method of providing the black matrix on the color filter substrate 5 to shield the leaky light and the method of providing the insulating planarization layer 15 to improve the planarity of the transparent electrode 16 according to the present invention and additionally by reducing the region of shielding the leaky light with the black matrix as compared with the related art. However, in consideration of the minimum line width of the black matrix, the accuracy of alignment of the color filter substrate 5 and the TFT substrate 1, and a process margin, for example, there is a possibility that the region of shielding the leaky light with the black matrix may eventually increase to result in an insufficient effect of improving the transmissivity.

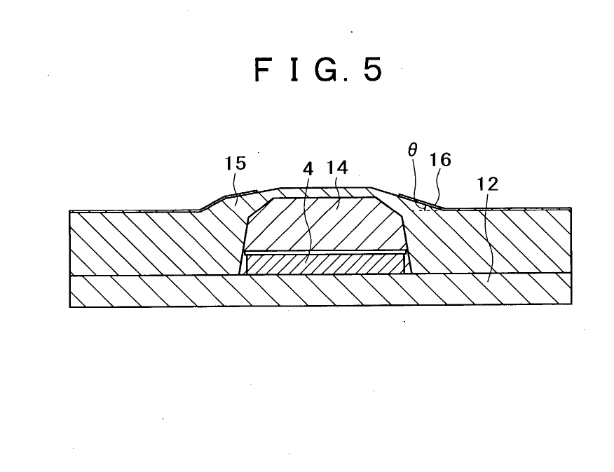

The above effects obtained by providing the insulating planarization layer 15 can be obtained also in the case that the reflective irregularity forming layer 14 is extensively formed between the signal line 4 and the insulating planarization layer 15 as shown in FIG. 5.

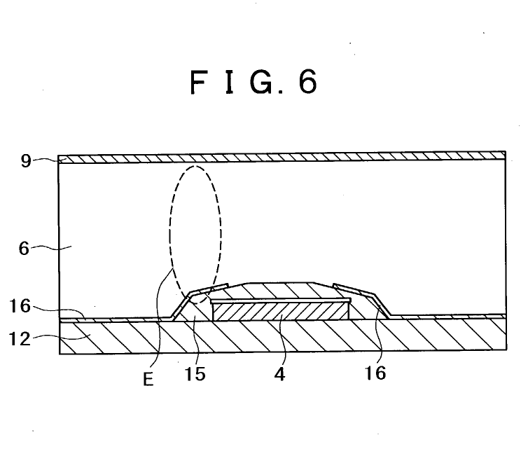

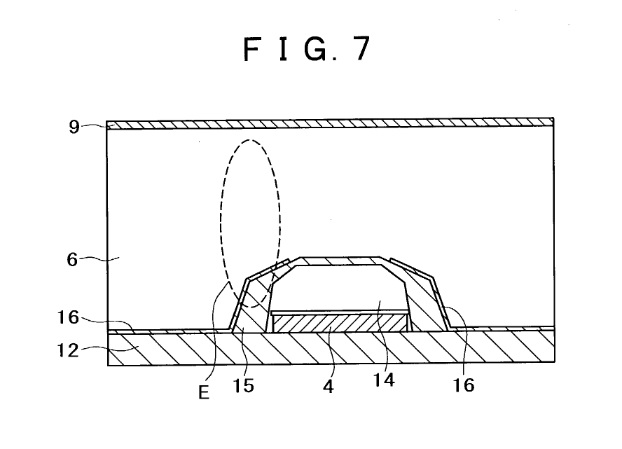

If the insulating planarization layer 15 is formed only in the vicinity of the signal line 4 for the purpose of only insulation between the signal line 4 and the transparent electrode 16, and a main portion of the transparent electrode 16 is formed directly on the transparent insulating substrate 12 as shown in FIG. 6, there arises a problem of disorder of liquid crystal orientation or phase difference deviation due to lack of the cell gap, for example, in a region E corresponding to a step produced by the transparent electrode 16, causing the leakage of light in the black display state. As a result, a reduction in contrast in the liquid crystal display is invited. Further, in the case that the reflective irregularity forming layer 14 is extensively formed between the signal line 4 and the insulating planarization layer 15 as shown in FIG. 7, the step becomes steeper to cause a remarkable reduction in contrast.

According to the liquid crystal display of the present invention as described above, the underlayer of the transparent electrode 16 is planarized by the insulating planarization layer 15. Therefore, it is possible to prevent the leakage of light in the black display state to thereby attain a image display having a high contrast. In addition, it is possible to overlap the signal line 4 and the transparent electrode 16 each other by planarizing the step of each signal line 4 to thereby obtain a high transmissivity by enlarging the transmissive display region B. Furthermore, the black matrix, which is conventionally provided for shielding the leakage of light in the black display state, is eliminated to thereby remarkably improve the transmissivity. As a result, according to the present invention, it is possible to implement a liquid crystal display based on a transmissive display assuring the high contrast and improving the opening ratio of the transmissive display region B.

Preferably, each signal line 4 adjacent to the transmissive display region B is formed directly on the transparent insulating substrate 12 so as to be substantially flush with the transparent electrode 16 in the transmissive display region B as shown in FIG. 4. With this structure, the step between the region corresponding to each signal line 4 and the transmissive display region B can be minimized and the fabrication process can be made easy.

The insulating planarization layer 15 in the transmissive display region B is formed as at least a part of the reflective display region A, specifically, at a part of the planarization layer 15a and the reflective irregularity forming layer 14, thereby allowing easy formation of the insulating planarization layer 15 without increasing the number of fabrication steps More preferably, the insulating planarization layer 15 is formed by extending the planarization layer 15a in the reflective display region A. In the case that an increase in the number of fabrication steps is not taken into account, the insulating planarization layer 15 in the transmissive display region B may be formed independently of a part of the reflective display region A.

The insulating planarization layer 15 may be formed by first coating a photosensitive material by a wet process, more specifically, by spin coating excellent in irregularity filling performance, and next performing photolithography, more specifically, varying exposure conditions between the reflective display region A and the transmissive display region B so that the film thickness in the transmissive display region B becomes smaller than that in the reflective display region A. Accordingly, the insulating planarization layer 15 can be easily formed without increasing the number of fabrication steps.

It is important that the material of the insulating planarization layer 15 be transparent because it is a component of the transmissive display region B. Specific examples of this material may include acrylic resins, novolac resins, polyimides, siloxane polymers, and silicon polymers. Of these resin materials, acrylic resins are preferable. To form the insulating planarization layer 15 in the transmissive display region B without increasing the number of fabrication steps, a photosensitive material usable in photolithography is preferably used as the material of the insulating planarization layer 15. Further, it is also important to use a material that can be formed into the insulating planarization layer 15 by coating such as spin coating in order to obtain high planarity. Examples of such a material may include organic materials such as resin materials as mentioned above and SOG (Spin On Glass) materials containing SiO₂ as a principal component.

While the step of the signal line 4 can be reduced by the insulating planarization layer 15, the shape of the signal line 4 slightly appears to the surface of the insulating planarization layer 15 as shown in FIGS. 4 and 5, and it is therefore not necessary to make the surface of the insulating planarization layer 15 completely flat. However, if the surface of the insulating planarization layer 15 is too nonflat, the planarity of the transparent electrode 16 is lost. Accordingly, letting d(T) denote the cell gap in the transmissive display region B, the planarity of the transparent electrode 16 (the degree of irregularity of the surface of the transparent electrode 16) in the transmissive display region B is set to preferably d(T)×0.2 or less, more preferably d(T)×0.07 or less.

Further, as shown in FIGS. 4 and 5, the planarization angle θ of the insulating planarization layer 15 (the tilt angle of the insulating planarization layer 15 from a position corresponding to the transparent insulating substrate 12 in the transmissive display region B to a position corresponding to the signal line 4) is preferably set to 20° or less, thereby reliably obtaining the effect of suppressing the leakage of light in the black display state.

The height of the signal line 4 causing the irregularity of the insulating planarization layer 15 is usually set in the range of 0.1 μm to 1 μm. The degree of irregularity of the insulating planarization layer 15 formed in the transmissive display region B is preferably set to a value 0.5 times the height of the signal line 4.

To realize good image display on the liquid crystal display according to the present invention, the cell gap in the reflective display region A and the cell gap in the transmissive display region B are required to satisfy a predetermined relation.

In the liquid crystal display of a multigap type such that the cell gap in the reflective display region A and the cell gap in the transmissive display region B are different from each other as shown in FIG. 2, there will now be described optimum values for the cell gaps in the reflective display region A and the transmissive display region B.

The light to be displayed from the transmissive display region B is emitted from the backlight 25 and next once passed through the liquid crystal layer 6. In contrast, the light to be displayed from the reflective display region A is the ambient light entered from the display surface, passed through the liquid crystal layer 6, reflected on the reflective electrode 17, and passed through the liquid crystal layer 6 again. Thus, the incident ambient light is twice passed through the liquid crystal layer 6.

Letting d(T) denote the optical path length in the transmissive display region B, that is, the cell gap in the transmissive display region B and d(R) denote the cell gap in the reflective display region A, d(T) is preferably set to a value about two times d(R). More specifically, the optimum range of d(T) is given by the following expression.

1.4×d(R)<d(T)<2.3×d(R) (1)

If d(T)<1.4×d(R), the transmissivity in the transmissive display region B is reduced and the efficiency of use of the light from the backlight 25 is therefore greatly lowered. Conversely, if d(T)>2.4×d(R), the voltage dependence of gray scale between the reflective display region A and the transmissive display region B is impaired to cause a possibility that different images may be displayed in the reflective display region A and the transmissive display region B.

The cell gap in the reflective display region A is determined in the following manner. Letting α denote the phase difference in the liquid crystal layer 6 when a minimum voltage (usually no voltage) is applied to the liquid crystal layer 6 and β denote the phase difference in the liquid crystal layer 6 when a maximum voltage is applied to the liquid crystal layer 6, the difference between α and β is preferably set to about λ/4. Also in the case that the liquid crystal molecules in the liquid crystal layer 6 are twist-oriented, the difference between α and β is preferably set to about λ/4 in appearance. In this description, λ is the wavelength of light, and in the case of a normal liquid crystal display, a wavelength of about 550 nm providing high visibility is used as the wavelength λ.

The phase difference in the liquid crystal layer 6 is determined by the refractive index anisotropy Δn of the liquid crystal molecules, the cell gap d of the liquid crystal layer 6, and the orientation of the liquid crystal molecules.

The refractive index anisotropy Δn is restricted to some range, so that an optimum value for the cell gap d is also restricted to some range. If the cell gap d is too large, the response speed of the liquid crystal molecules is greatly reduced, whereas if the cell gap d is too small, the control of the cell gap d is difficult.

In consideration of the above properties, it is preferable to satisfy the following relation for the cell gap d(R) in the reflective display region A.

1.5 μm<d(R)<3.5 μm (2)

Further, it is preferable that the step between the reflective display region A and the transmissive display region B satisfies the conditions of Eqs. (1) and (2) mentioned above. That is, the condition of 1.4×d(R)<d(T)<2.3×d(R) is given from Eq. (1). Accordingly, it is preferable that the cell gap d(T) in the transmissive display region B falls within the range of 2.1 μm<d(T)<8.05 μm from the conditions of Eqs. (1) and (2).

If the film thickness of the insulating planarization layer 15 is too large, the necessary step, between the reflective display region A and the transmissive display region B is filled with the insulating planarization layer 15. Accordingly, the film thickness of the insulating planarization layer 15 is preferably set to 40% or less of the step between the reflective display region A and the transmissive display region B of the TFT substrate 1. More specifically, in consideration of the above conditions for the cell gaps d(T) and d(R), it is preferable that the film thickness of the insulating planarization layer 15 falls within the range of 0.2 μm to 1 μm.

In the liquid crystal display shown in FIG. 2, the height of the reflective display region A in the TFT substrate 1 is set to greater than a normal height, thereby optimizing the cell gap d(R) in the reflective display region A and the cell gap d(T) in the transmissive display region B as mentioned above. More specifically, the film thicknesses of the reflective electrode 17 and the reflective irregularity forming layer 14 are reduced to thereby reduce the cell gap d(R) in the reflective display region A, thus adjusting the optical path length in the reflective display region A.

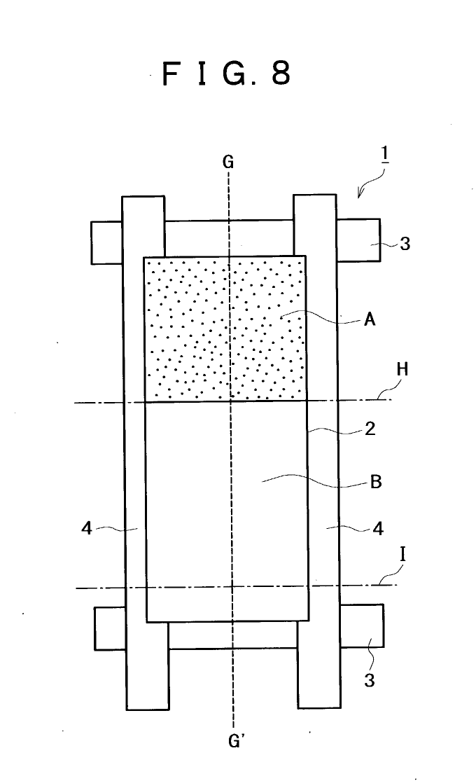

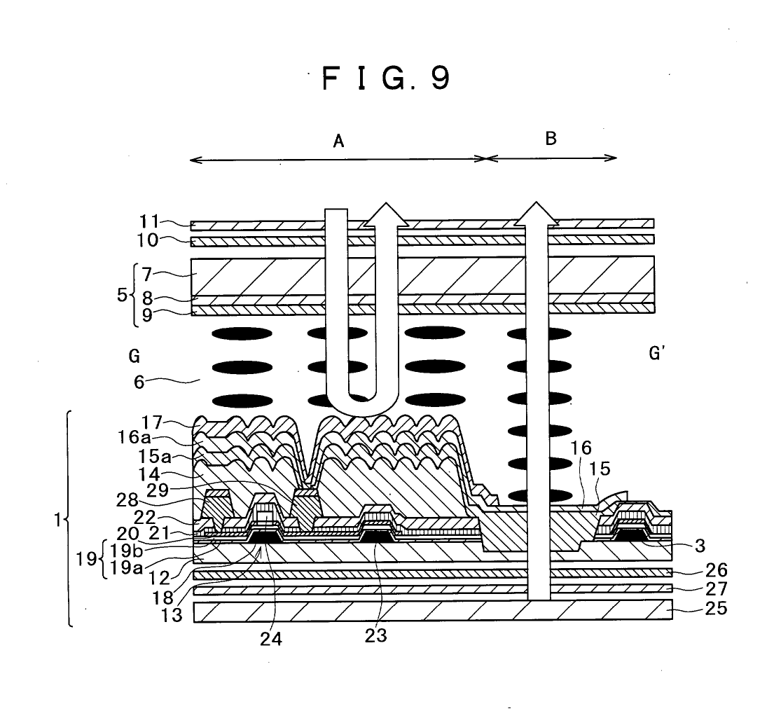

The optimization method for the cell gaps in the reflective display region A and the transmissive display region B is not limited to the above method, but a method of recessing the surface of the transparent insulating substrate 12 at a portion corresponding to the transmissive display region B may be adopted to thereby increase the cell gap in the transmissive display region B as shown in FIGS. 8 and 9. According to this method, the thickness of the insulating planarization layer 15 extended in the transmissive display region B can be reduced by the recess formed on the surface of the transparent insulating substrate 12, thereby easily providing the necessary step between the reflective display region A and the transmissive display region B. The recess of the transparent insulating substrate 12 may be formed by excessively etching the transparent insulating substrate 12 in patterning the gate electrode 19 by dry etching or the like.

The recess of the transparent insulating substrate 12 is formed in a region defined between a dashed line H and a dashed line I in FIG. 8, and there is a region where the transparent insulating substrate 12 is not recessed in the transmissive display region B. Since the gate insulator 19 must be left on the gate line 3 adjacent to the transmissive display region B, the transparent insulating substrate 12 is not etched in the vicinity of the gate line 3 adjacent to the transmissive display region B. To the contrary, the surface of the transparent insulating substrate 12 at a portion under each signal line 4 is removed by etching.

In modification, the above-mentioned methods may be combined to optimize the cell gaps in the reflective display region A and the transmissive display region B.

While the method of covering and planarizing the step of each signal line 4 in the transmissive display region B has been described above, a similar method can be applied also in the case of covering and planarizing the step of the gate line 3 in the transmissive display region B as shown in FIG. 2.

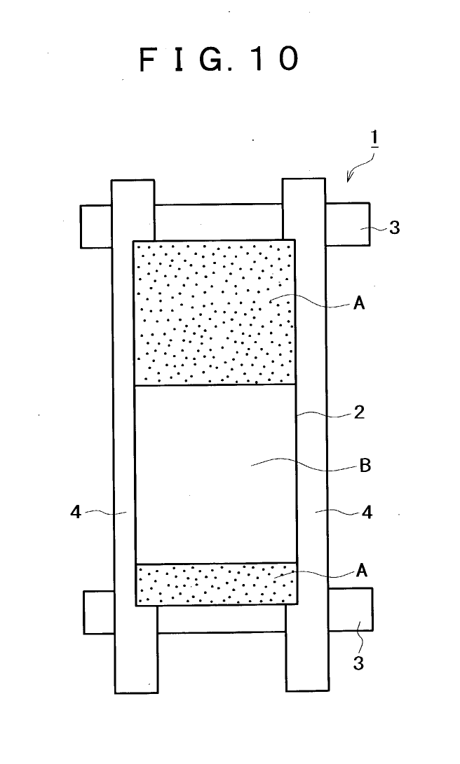

Further, while each pixel 2 is divided into two regions, that is, the reflective display region A and the transmissive display region B in the above preferred embodiment shown in FIG. 1, the present invention is not limited to this configuration. For example, each pixel 2 may be divided into three regions so that another reflective display region A is formed between the transmissive display region B and the gate line 3 adjacent thereto as shown in FIG. 10. Further, the present invention is applicable also to the conventional configuration as shown in FIG. 11 such that the transmissive display region B is surrounded by the reflective display region A in each pixel 2.

According to the present invention as described above, it is possible to provide a combined reflective/transmissive liquid crystal display, which can prevent the leakage of light in the black display state to thereby realize a high contrast and can also enlarge a transmissive display region to thereby obtain a high transmissivity.

While a preferred embodiment of the invention has been described using specific terms, such description is for illustrative purposes only, and it is to be understood that changes and variations may be made without departing from the spirit or scope of the following claims.

What is claimed is:

1. A liquid crystal display comprising a pair of substrates, a liquid crystal layer sandwiched between said substrates, a pixel having a transmissive display region for displaying with transmitted light and a reflective display region for displaying with reflected light, a drive element for driving said pixel, a signal line for supplying a display signal to said drive element, and a gate line for supplying a scan signal to said drive element;
one of said substrates comprising an insulating planarization layer for planarizing a step produced by said signal line and/or said gate line, and a transparent electrode formed on said insulating planarization layer in said transmissive display region.

2. A liquid crystal display according to claim 1, wherein said pixel is divided in one direction to form said transmissive display region and said reflective display region.

3. A liquid crystal display according to claim 2, wherein the thickness of said liquid crystal layer in said reflective display region is different from that in said transmissive display region.

4. A liquid crystal display according to claim 3, wherein said insulating planarization layer comprises at least a part of a layer constituting said reflective display region.

5. A liquid crystal display according to claim 4, wherein said layer constituting said reflective display region comprises at least one of a reflective irregularity forming layer and a planarization layer formed in said reflective display region.

6. A liquid crystal display according to claim 5, wherein said insulating planarization layer comprises a part of said planarization layer extending from said reflective display region.

7. A liquid crystal display according to claim 3, wherein the thickness of said insulating planarization layer is set to 40% or less of the height of a step produced between said reflective display region and said transmissive display region.

8. A liquid crystal display according to claim 3, wherein the height of a step produced by said transparent electrode is set to d(T)×0.2 or less where d(T) is the thickness of said liquid crystal layer in said transmissive display region.

9. A liquid crystal display according to claim 8, wherein the height of said step is set to d(T)×0.07 or less where d(T) is the thickness of said liquid crystal layer in said transmissive display region.

10. A liquid crystal display according to claim 3, wherein the thickness d(T) of said liquid crystal layer in said transmissive display region and the thickness d(R) of said liquid crystal layer in said reflective display region satisfy the relation of 1.4×d(R)<d(T)<2.3×d(R).

11. A liquid crystal display according to claim 3, wherein the thickness d(R) of said liquid crystal layer in said reflective display region satisfies the relation of 1.5 μm<d(R)<3.5 μm.

12. A liquid crystal display according to claim 3, wherein the planarization angle of said insulating planarization layer tilted at said step produced by said signal line and/or said gate line is set to 20 or less.

13. A liquid crystal display according to claim 3, wherein the surface of said substrate having said insulating planarization layer is recessed at a portion corresponding to said transmissive display region.

14. A liquid crystal display according to claim 1, wherein said insulating planarization layer contains a photosensitive material.

15. A liquid crystal display according to claim 1, wherein said insulating planarization layer contains a transparent material.

16. A liquid crystal display according to claim 1, wherein said insulating planarization layer contains a resin.

17. A liquid crystal display according to claim 1, wherein said insulating planarization layer is formed by coating.
